(19) United States
(12) Patent Application Publication
(10) Pub. No.: US 2006/0074959 A1
(43) Pub. Date: Apr. 6, 2006

(54) Maximum likelihood based interference cancellation for space-time coded signals

(75) Inventors: Paul Nicholas Fletcher, Malvern (GB); Michael Dean, Malvern (GB); Robert Jan Piechocki, Bristol (GB); Andrew Nix, Bristol (GB); Nishan Canagarajah, Bristol (GB); Joe McGeehan, Bristol (GB)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: QinetiQ Limited

(21) Appl. No.: 10/526,266

(22) PCT Filed: Sep. 1, 2003
(86) PCT No.: PCT/GB03/03741

§ 371 Date: Mar. 2, 2005

(30) Foreign Application Priority Data
Sep. 3, 2002 (GB) 0220399.0

(51) Int. Cl. G06F 17/30

(52) U.S. Cl. 707/102

(57) ABSTRACT

A signal processing apparatus comprises a plurality of receiving elements, weighting means, and decoding means. Each of the receiving elements has respective weighting means associated therewith at the decoding means, and is arranged to receive a plurality of signals transmitted from a plurality of transmitters. The weighting means are arranged to apply a complex weighting function to each of a number of the signals received by the receiving elements at a given frequency in order to null the number of signals. The decoding means are arranged to determine a symbol or codeword associated with a non-nulled signal and to incorporate the symbol or codeword in the determination of at least one further symbol or codeword.

This invention relates to a signal processing method and apparatus. More particularly, but not exclusively, it relates to a method and apparatus for decoding symbols and/or codewords in a multiple input-multiple output orthogonal frequency division multiplex wireless network system.

It is known to convert a stream of serial data symbols to a parallel block of data symbols and transmit each of the symbols via a respective one of a number of transmitters in order to increase data transfer rate across a wireless network, for example the BLAST architecture. Space-time coding improves the quality of data links between transmitter and receiver by increasing redundancy in codewords transmitted compared to the input symbols and by producing multiple codewords with significant differences therebetween for each frame of symbols coded.

Space-time trellis codes (STTC) bridge the divide between the two above-mentioned techniques wherein individual parallelised data streams are protected by space-time codes. This yields improved performance in terms of the robustness of communications and therefore gives an improved veracity of data .associated with space-time codes. Such a system is particularly attractive for multiple input-multiple output systems that have a large number of antenna elements, for example four or more transmitters and four or more receivers. This is due to the system allowing high data transfer rates with high confidence in data transfer quality.

Upon receiving a corrupted codeword an ideal STTC receiver performs a search over all possible codewords and chooses a vector or symbols that maximises a likelihood function, for example using a Viterbi decoder on codewords received by a number of antennas. However, the complexity of the solution of such a likelihood function increases exponentially with the number of transmitter elements. Also, increasingly complex modulation schemes can be employed, for example 64 quadrature amplitudes modulation (QAM). In 64-QAM there are sixty-four distinct symbols in vector space, each one representing a six bit binary sequence. This too adds to the complexity of solving the vector Viterbi equation. Thus, a computational solution to the problem is prohibitively computationally complex to implement practically.

One approach to reduce the computational complexity of solving a maximum likelihood equation is to employ group interference suppression (GIS). In GIS spatial suppression of codewords originating from undesired transmitters occurs at the receivers leaving only a codeword from a desired transmitter to be detected. This is achieved by weighting signals received at the receivers in order to produce a zero, or near zero, signal in a given direction, a process known as “nulling”. It will be appreciated that the terms direction may not be a physical direction in the case of an indoor or multipath rich environment.

Once the desired codeword is determined the entire nulling process has to be repeated for the next codeword. This is clearly a cumbersome and time consuming process.

In orthogonal frequency division multiplexing (OFDM) as shown in FIG. 2 a number of sub-carrier frequencies, each being a harmonic of a fundamental, lowest frequency, sub-carrier, have complex data values imposed upon them by use of an inverse fast Fourier transform (IFFT) unit. The complex data values vary the phase and amplitude of the sub-carriers away from their unperturbed state. Upon transmission, the sub-carriers superpose to produce a non-sinusoidal signal. Upon reception of the signal by a receiver a fast Fourier transform (FFT) is carried out upon the signal to recover the sub-carriers and hence their associated data values. A typical wireless local area network (WLAN) data transmission will include sixty-four sub-carriers, for example Hiperlan 2 and IEEE 802.11a.

In the case of an OFDM STTC system each sub-carrier frequency from one transmitter will interfere with the same sub-carrier frequency originating from any other transmitter. There will however be no interference between sub-carriers of different frequencies when the cyclic prefix is at least as long as the channel excess delay. Thus, in an OFDM STTC system the complexity of applying a conventional GIS solution increases many fold, as spatial nulling has to be performed not only for each receiver element but also at each individual sub-carrier frequency. This substantially increases the complexity of implementation of such a system and increases the computational complexity of the GIS technique still further.

It is an object of the present invention to provide a method of signal processing that, at least partially, ameliorates at least one of the above-mentioned problems and/or disadvantages.

It is a further object of the present invention to provide a signal processing apparatus that, at least partially, ameliorates at least one of the above-mentioned problems and/or disadvantages.

According to a first aspect of the present invention there is provided a method of determining each of a plurality of data symbols or codewords from a plurality of signals comprising the steps of:

(i) weighting a number of said signals so as to substantially null said number of signals, using weighting means;

(ii) determining a symbol or codeword associated with a, or each, non-nulled signal using processing means arranged to execute a maximum likelihood estimation process upon said, or each, non-nulled signal;

(iii) reducing the number of signals nulled by the weighting means by at least a number of non-nulled signals in step (ii);

(iv) altering the maximum likelihood metric in accordance with the data symbol derived at step (ii); and

(v) repeating steps (ii) to (iv).

This method has the advantage over prior art methods that as successively fewer input sources are suppressed, nulled, at each iteration of the method the number of spatial degrees of freedom available for sampling increases due to step (iv). This increases diversity on receive for sampling, which in turn increases the confidence with which later data symbols can be determined.

The method may include sampling data, typically channel state information (CSI), to determine which signals are to be nulled at either, or both, of steps (i) and (iii). The method may include selecting signals with lowest input power to be nulled at either, or both, of steps (i) and (iii). This has the advantage that those signals with the highest input power have their associated data symbols determined first. This is important as high input powers are usually associated with high signal to noise ratios and thus confidence in the initially determined symbols is increased. High confidence in the initially determined symbols is important as any subsequent determination of further symbols employs these initial symbols and errors propagate in such a trellis-coded system.

The method may include determining symbols that are, or form part of, codewords, the codewords typically being associated with streams of symbols input to a transmitting means.

The method may include separating frequencies of at least some of the plurality of signals by multiples of a harmonic frequency. The method may include orthogonalising the plurality of signals. Thus, the method is directly applicable to orthogonal frequency division multiplexing (OFDM) of signals.

The method may include providing a plurality of receivers arranged to receive said plurality of signals prior to step (i). The method may include transmitting a signal that is a sum of said signals from a plurality of spatially separated transmitters.

The method may include deriving a matrix of complex weighting co-efficients by the processing means to be applied to said weighting means in order to null said signals at either of steps (i) or (ii).

The method may also include applying said weighting coefficients to said weighting means.

The method may include using the vector Viterbi algorithm at step (ii).

The method may include parallelising an input serial stream of data symbols prior to transmission.

The method may include coding a frame of parallelised data symbols typically using space-time coding prior to transmission.

The method may include coding a frame of 2ⁿ parallelised data symbols prior to transmission, where n is an integer selected from the following list: 1, 2, 3, 4, 5, 6, 7, 8, 16, 32, 64, 128, >128.

The method may include producing at least one codeword, preferably two, during the coding operation.

The method may include reducing the number of nulled channels between steps (ii) and (iv).

The method may include increasing the diversity upon receive of the plurality of signals.

According to a second aspect of the present invention there is provided a signal receiving apparatus comprising a plurality of receiving elements, weighting means, and decoding means, each of the receiving elements having respective weighting means associated therewith, each of the receiving elements being arranged to receive a plurality of signals transmitted from a plurality of transmitters, the weighting means being arranged to apply a complex weighting function to each of a number of said signals received by the receiving elements at a given frequency in order to null said number of said signals, the decoding means being arranged to determine a symbol or codeword associated with a non-nulled signal and to incorporate said symbol or codeword in the determination of at least one further symbol or codeword.

The receiving apparatus may include at least four receiving elements.

Each receiving element may have a channel state information (CSI) unit associated therewith, and each CSI unit may be arranged to compensate for distortion to the signal received by the apparatus due to variations in the transmission path of said signal.

The receiving apparatus may include an FFT unit between each receiving element and the decoding means, and the FFT units may be arranged to separate each of a plurality of sub-carrier signals from said received signals.

The decoding means may include processing means arranged to carry out a maximum likelihood estimation procedure upon a sub-carrier signal received at a receiving element in order to determine the symbol.

The processing means may be arranged to carry out whole vector Viterbi decoding upon the signal.

The apparatus is preferably arranged to execute a method in accordance with the first aspect of the present invention.

According to a third aspect of the present invention there is provided a method of increasing data transfer capacity across a network comprising the steps of:

(i) receiving a signal comprising a plurality of data carrying sub-channels transmitted by a plurality of transmitter elements at a plurality of receiving elements;

(ii) suppressing a component of the signal associated with a given sub-channel transmitted by all but one transmitting element;

(iii) determining a symbol or codeword associated with said signal received on said given sub-channel at said one receiving element using a maximum likelihood estimation process; and

(iv) incorporating the symbol or codeword into the maximum likelihood estimation process for the determination of at least one other symbol or codeword.

The method may include parallelising data and encoding the data as a symbol or a space time codeword prior to transmission of the symbol or codeword over the network.

The method may include providing more than four receiving elements arranged to receive the signal from the network, and the method may include providing more than four transmission elements arranged to transmit the signal over the network.

The method may include applying a whole vector Viterbi decoding to the signal at step (iii).

The method may include providing the network in the form of a wireless local area network (WLAN), for example IEEE802.11a, HiperLan 2 or Bluetooth networks or a telecommunications network. It will be appreciated that in the case of current narrow band Bluetooth networks space-time trellis coding is applied.

According to a fourth aspect of the present invention there is provided a computer readable medium having stored therein instructions for causing a device to execute the method according to either of first or third aspects of the present invention.

According to a fifth aspect of the present invention there is provided a program storage device readable by a machine and encoding a program of instructions which when operated upon the machine cause the machine to operate as the apparatus in accordance with the second aspect of the present invention.

The invention will now be further described, by way of example only, with reference to the accompanying drawings, in which:

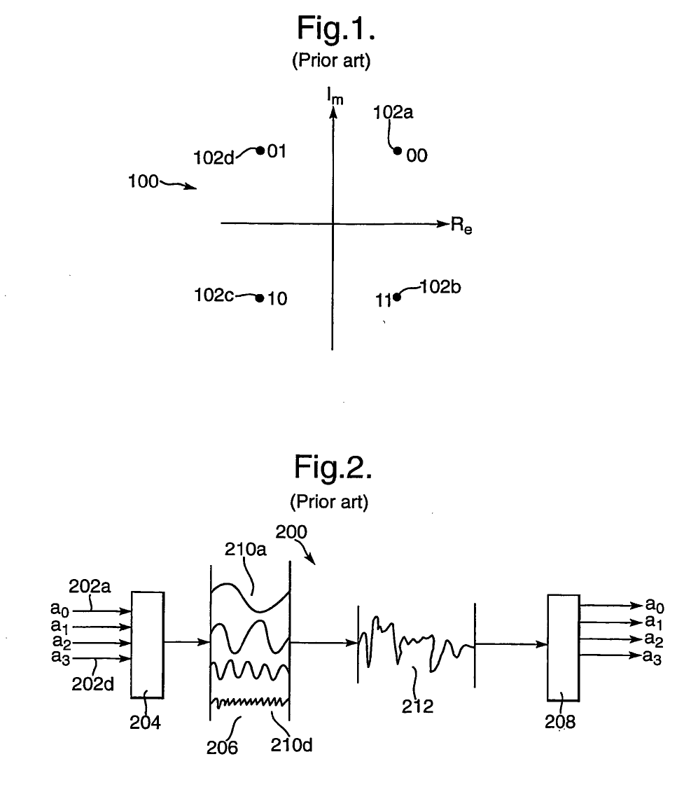

FIG. 1 is a representation of a quaternary phase shift keying (QPSK) signalling scheme of the prior art;

FIG. 2 is a representation of an orthogonal frequency division multiplexing (OFDM) modulation scheme of the prior art;

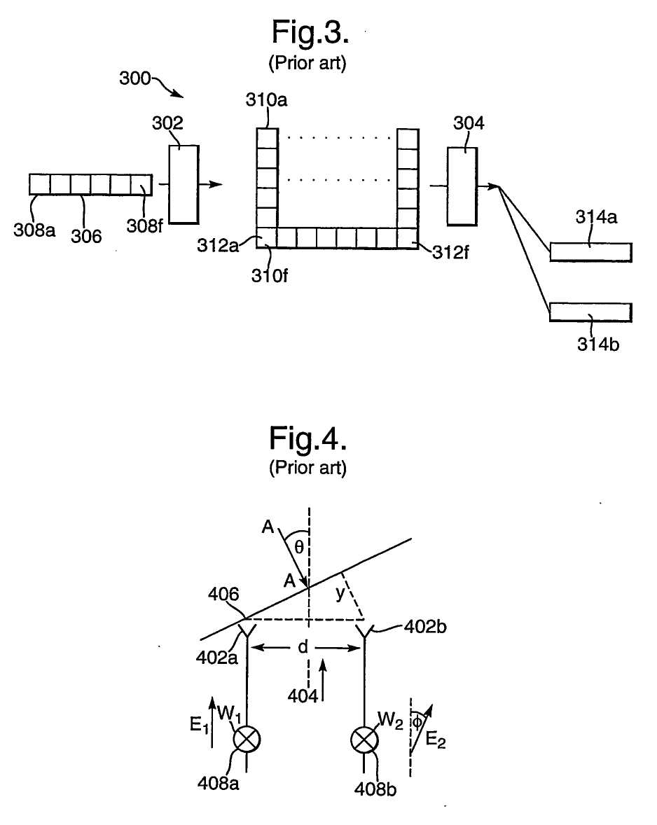

FIG. 3 is a schematic representation of generation of codewords from a serial input streams of data, of the prior art;

FIG. 4 is a schematic representation of a spatial nulling scheme of a phased array antenna of the prior art;

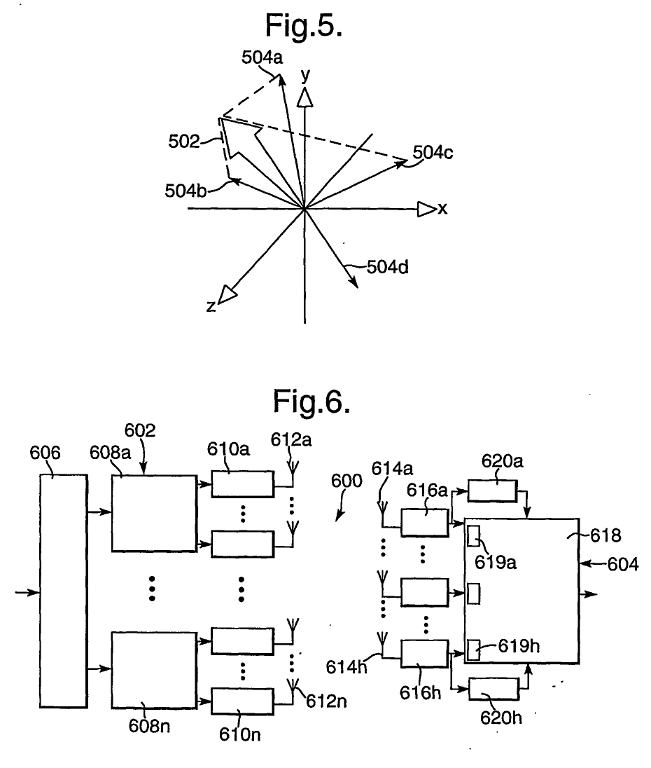

FIG. 5 is a representation of possible symbols and a data vector according to both the prior art and the present invention;

FIG. 6 is a schematic representation of a wireless multiple input-multiple output (MIMO) space-time trellis coding (STTC) system according to at least an aspect of the present invention;

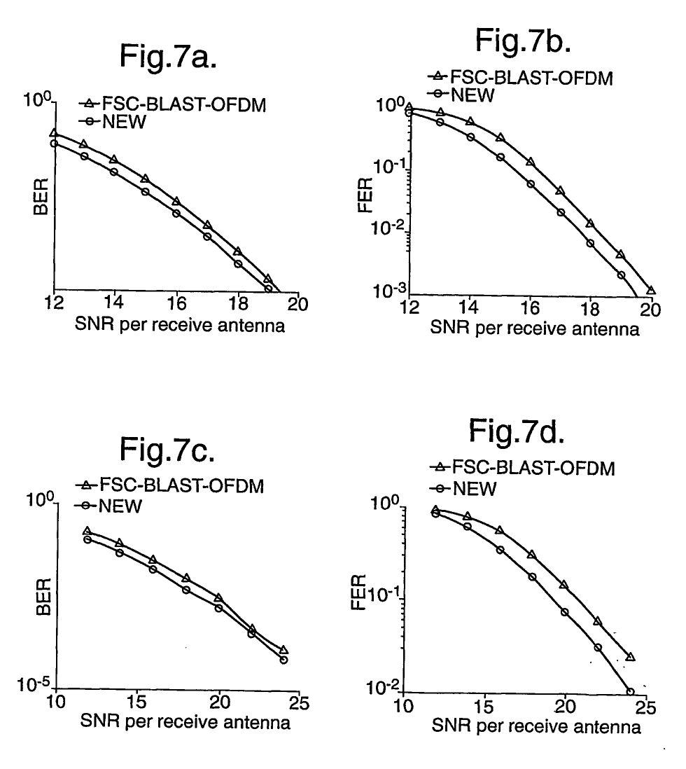

FIGS. 7a to 7d are graphs showing an improvement in performance of a receiver according to an aspect of the present invention compared to a prior art receiver;

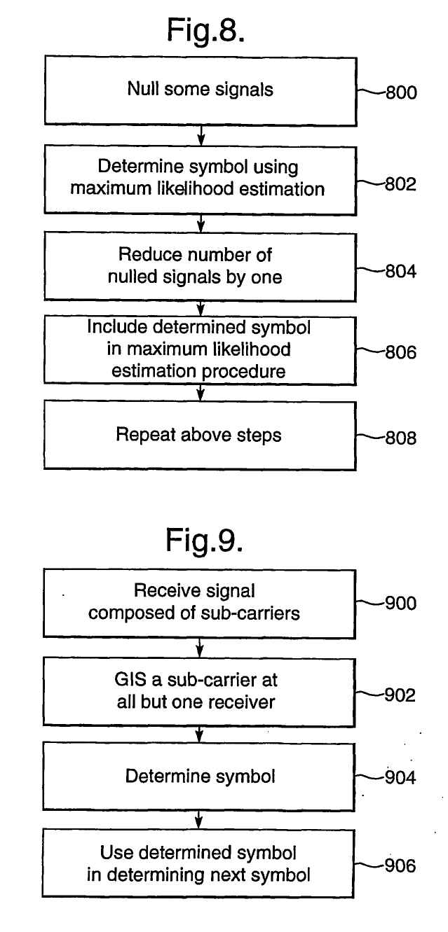

FIG. 8 is a flow diagram detailing a method of signal processing in accordance with to the first aspect of the present invention; and

FIG. 9 is a flow diagram detailing a method of signal processing in accordance with the third aspect of the present invention.

Referring now to FIG. 1, a constellation 100 of a known quaternary phase shift keying (QPSK) signalling scheme comprises four symbols 102a-d spaced apart in the complex plane. The relative complex and real components of the symbols 102a-d denote which two bit binary sequence is represented by a given symbol, for example positive real and positive imaginary components, symbol 102a represent the two bit binary sequence 00. Thus it is possible to represent two bits using a single symbol using QPSK, effectively doubling the bit rate over direct binary signalling.

Referring now to FIG. 2, an orthogonal frequency division multiplexing arrangement 200 comprises four input channels 202a-d, an inverse fast Fourier transform (IFFT) unit 204, and a fast Fourier transform unit 208 (FFT).

The IFFT units 204 generate, in this case, four sinusoidal sub-carriers 210a-d. The first sub-carrier 210a has a frequency and constitutes a fundamental of the system. Each of the other three sub-carriers 210b-d have frequencies that are multiples of the frequency of the fundamental 210a, that is to say that they are harmonics of the fundamental 210a.

The input channels 202a-d carry digitised data to the IFFT unit 204 where the data is converted to a complex value. Each complex value is applied to a respective sub-carrier 210a-d. This has the effect of varying the phase and amplitude of the respective sinusoidal sub-carriers 210a-d.

The sub-carriers 210a-d are combined to form a non-sinusoidal carrier wave 212. The carrier wave 212 is transmitted to a receiver where the FFT unit 208 separates out the sub-carriers 210a-d and extracts the complex weightings from them. These complex weightings are then decoded to recover the strings of data applied at the input channels 202a-d.

Referring now to FIG. 3, an encoder 300 comprises a serial to parallel converter 302 and a codeword generator 304. In use, a serial string of data 306 comprising a plurality of data blocks 308a-f spaced apart in time, is input into the convertor 302. The blocks 308a-f are output from the convertor 302 at a plurality of output channels 310a-f simultaneously. This allows either the discrete output of data from a single data block of a serial data stream or alternatively the construction of multiple serial frames from data blocks spaced apart within the initial serial data stream 306. For example, in this case every seventh block of data will be placed adjacent each other in a new frame 312a-f. These frames can be of indeterminate or user defined lengths.

Each of the frames 312a-f is coded into two codewords 314a, b by the generator 304. The two codewords 314a, b have a high degree of redundancy and have differences between them maximised. This results in small variations in the input frames 312a-f giving large differences between codewords, for example a one bit difference between two frames can result in the variations of four or five symbols in the codewords generated by the generator 304. Also, the coding process builds in an element of memory to the codewords, in that the codewords generated yield information about data within a given frame.

It is these codewords that are transmitted via the sub-channels in an OFDM system. In a multiple input-multiple, output (MIMO) OFDM system each codeword is sent to a respective transmission antenna, typically two or more antennas as this increases spatial diversity on transmit.

The reception antennas can be arranged to co-operate in order to spatially reject transmitted signals, by group interference suppression (GIS), this is shown in FIG. 4.

Referring now to FIG. 4, this shows the case for a plane wave incident upon a detector array two receiving elements 402a, b define an array aperture 404. A wavefront 406 is incident upon the aperture 404, at an angle θ to the normal of the aperture 404, along a vector A-A. Considering the two receiving elements 402a, b, the wavefront 406 must travel an additional distance y after being received by the element 402a before being received by the element 402b. From a simple geometric consideration it can be seen that y=d sin θ. This extra distance of travel introduces a phaseshift between the wavefront received at the two elements 402a, b, of:

$$Φ = ( \frac{2 π}{λ} ) d Sin θ \qquad ( Equation 1 )$$

Weighting units 408a, b apply a correction in order that the electric vectors of the respective fractions of the wavefront 406 detected at the receiving elements 402a, b are aligned prior to exiting this arrangement. Thus it can be seen that by altering weightings applied to the fractions of the wavefront 406 at the weighting units 408a, b the antenna array can be spatially scanned as each directions will exhibit a unique phase relationship between the receiving elements 402a, b.

It will be appreciated that the present invention is not limited to a plane wave situation and the above description should not be taken as limiting.

Referring now to FIG. 5, a transmitted codeword, represented as a vector 502, is placed in a Cartesian framework. Any one of a number of possible symbols 504a-d within the signalling scheme could correspond to the transmitted symbol upon reception, and in order to determine between them a measure must be made of the straight line distance between the terminal points of the vectors representing the codewords. The shortest Euclidean distance will constitute the best fit between the transmitted symbol upon reception and the allowable symbols within the signalling scheme.

Referring now to FIG. 6, a wireless MIMO OFDM network 600, for example a wireless local area network (WLAN) or mobile telecommunications network, comprises a transmitter unit 602 and a receiver unit 604.

The transmitter unit 602 comprises a serial to parallel converter 606, typically a BLAST architecture, a frequency space encoder 608a-n, a plurality of IFFT units 610a-n and a plurality of transmit antenna 612a-n. Each antenna 612a-n is connected to a respective IFFT unit 610a-n.

The receiver unit 604 comprises a plurality of receive antenna 614a-h each of which is connected to a respective FFT unit 616a-h, a decoder 618, including weighting units 619a-h for GIS, and a plurality channel state information (CSI) modules 620a, h. Each CSI module 620a-h (only 2 shown) is associated with a respective FFT unit 616a-h and makes an estimation of the distortion to the received signals on each sub-carrier due to the path travelled by the received signal, for example, by reflections of the signal from surfaces in the transmission path etc. The CSI also corrects for this at the receiving unit 604 in order to recover the transmitted symbols.

The FFT units 616a-n separate out sub-carriers from a non-sinusoidal carrier wave. The sub-carriers are passed from the FFT units 616a-n to the decoder 618 where GIS is carried out, using the weighting units 619a-h. Frequency-space vector Viterbi decoding is also carried out on the sub-carriers at the decoder 618 such that symbols transmitted from the-transmission unit 602 can be recovered.

In a MIMO OFDM network sub-carriers with the same frequency will interfere with each other irrespective of which transmit antenna 612a-n they originate from. This necessitates signal processing at the receiver 604 in order to correctly decode codewords transmitted from transmitting antennas 612a-n, and hence recover transmitted data. In OFDM coding of symbols takes place across sub-carrier domains decoding takes place in both spatial and frequency (sub-carrier) domains. Thus, each transmit set of antennas 612a-n is suppressed in turn, using GIS, in order to null all but one group of transmitting antennas, decode the codeword and modify metrics used in maximum likelihood decoding of subsequent codewords.

This leads to linear equations to be solved where:

G is the number of transmit antenna groups;

Nₜ^{g} is the number of transmit antennas in the g th group (typically 2), where 1<g<G;

cₖ=(c¹ₖ, c²ₖ, . . . c^{g}ₖ)^{T} is the space-frequency symbol transmitted on the κ^{th} subcarrier frequency.

For example, if the g th group has 2 transmit antennas within it then c^{g}ₖ will actually consist of two symbols transmitted simultaneously from the transmit antennas. The symbols are part of the codeword that encompasses all the sub-carriers.
rₖ=Hₖ·\overline{c}ₖ+ηₖ (Equation 2)

rₖ is the received signal at the κ^{th} subcarrier frequency for all transmit antennas;

H is a matrix of the CSI for each sub-carrier;

ηₖ is the additive white Gaussian noise at the receivers

In order for a given receiver to decode the g th codeword the receiver suppresses space-frequency codewords originating from other groups of transmitters according to the following:
θₖ(cₖ^{g})rₖ=θₖ(cₖ^{g})Hₖ\overline{c}ₖ+θₖ(cₖ^{g})ηₖ (Equation 3)
Where:

θ_{K} (c^{g}ₖ) is an orthonormal basis set for null space of a matrix composed of all columns of Hₖ except for those corresponding to the transmit antennas forming the g th group whose codeword it is desired to decode.

The decoder 618 takes the signal received at the antennas 614a-n, and corrected for the signal path by the CSI units 620a-n, and executes whole vector Viterbi decoding upon the signal. The maximum likelihood (ML) codeword transmitted from the g th group of antennas is given by:

$$\tilde{c} = {arg min}_{( {00}_{c}^{g} 00 )} {\sum }_{k = 0}^{K - 1} {‖ {θ}_{k} ( {c}_{k}^{g} ) {r}_{k} - {θ}_{k} ( {c}_{k}^{g} ) {H}_{k} {\tilde{c}}_{k} ‖}^{2} \qquad ( Equation 4 )$$

Where:

\tilde{c} is the decoded codeword

K is the total number of sub-carriers used

Equation 4 describes the process of searching over all possible space-frequency codewords that could have been sent by the g th transmit antenna group and selecting the most likely codeword given that codewords from all other groups of transmit antennas have been excluded via the GIS procedure. Once the a codeword is decoded the whole process is repeated taking into account the decoding of the decoded codeword, according to the following:

$$\tilde{c} = {arg min}_{( 00 {\tilde{c}}^{g} 0 {c}^{{g}^{′}} )} {\sum }_{k = 0}^{K - 1} {‖ {θ}_{k}^{′} ( {c}_{k}^{{g}^{′}} ) {r}_{k} - {θ}_{k}^{′} ( {c}_{k}^{{g}^{′}} ) {H}_{k} {\tilde{c}}_{k}^{10} ‖}^{2} \qquad ( Equation 5 )$$

Where θ′ₖ(cₖ^{g′}) is an orthonormal basis for the null space of all columns of Hₖ except those corresponding to the transmit antennas of the current group g′ being decoded and all the transmit antennas of previously decoded codeword groups.

Any previously decoded codeword is accounted for by modifying the ML metric such that any previously decoded codeword no longer need be suppressed through the GIS process. Thus, on each iteration the number of constraints on the GIS nulling matrix is reduced and hence a larger number of degrees of freedom available on the received signal. This leads to greater spatial diversity and improved performance in terms of robustness of communications.

In prior art arrangements search space would have to be reformulated using GIS in order to determine each codeword. This is no longer true maximum likelihood as the search space is artificially restricted by GIS. Such an approach is sub-optimum.

In a detection scheme in accordance with the present invention the detector 618 determines which of the received codewords has the greatest signal strengths typically by use of a comparator that compares the power, calculated from each CSI vector, in order to determine the relative power of each channel, and hence signal. The detector 618 thus determines the most likely codeword using equations 1 and 3 as hereinbefore described.

This scheme has the effect of changing the mean of the noise vector of the system to become the first detected codeword. Thus, the first codeword is ignored during the GIS procedure in determining the second code. This allows more degrees of freedom, by freeing receiving antennas to be used in the detection of lower power signals, thereby increasing the signal to noise ratio of such signals due to the inherent increase in receive diversity.

The first detected space time stream is explicitly incorporated into the branch metrics of the detection of the second code.

At each detection step an additional degree of freedom is introduced into the receive diversity as an additional receiving antenna or antennas 614a-n can be used for reception of a codeword. This is because at each detection step the previously detected codeword is ignored by the GIS procedure.

Assuming that the first, and subsequent, codewords are detected perfectly there is no impact on the detection of subsequent codewords by the Viterbi detector 618.

Referring now to FIGS. 7a-d, the modelled performance of a system in accordance with the present invention is shown in comparison to the performance of a conventional frequency space coded (FSC)-BLAST-OFDM system using two transmit and four receiving antennas as shown in FIG. 6. FIGS. 7a and 7b being from a first decoding group (first two antennas) and FIGS. 7c and 7d being from a second decoding group. The system modelled has four codewords with two transmit antenna each, four receive antenna and assumed ideal channel state information, i.e. no distortion to the transmitted codes upon reception.

As can be seen from FIGS. 7a and 7c the bit error rate (BER) associated with the present invention is approximately 1.5-2 dB improved over the conventional FSC-BLAST-OFDM architecture at a given signal to noise ratio (SNR). This is however of only limited importance as the data transmitted over the network will usually be in the form of frames, typically fifty-four bytes in length. If an error is found in a frame the whole frame must be re-transmitted. Therefore what is of more interest than the BER is the frame error rate (FER). This is shown in FIGS. 7b and 7d and improvement of 1.5 to 2 dB in the FER over conventional FSC-BLAST-OFDM architectures is observed at a given SNR for an arrangement in accordance with the present invention.

Referring now to FIG. 8, a method of signal processing that increases diversity on receive for sampling, thereby increasing the confidence with which later data symbols can be determined, comprises weighting a number of received signals in order to substantially null them (Step 800). A data symbol or codeword associated a non-nulled signal is determined using signal processing means that are arranged to execute a maximum likelihood estimation process upon the non-nulled signal (Step 802).

The number of signals nulled by the weighting means is reduced by one, i.e. the signal for which the symbol or codeword had been determined (Step 804). The symbol determined is included in the maximum likelihood estimation procedure (Step 806) and another symbol or codeword is determined in the same manner as above (Step 808).

Referring now to FIG. 9, a method for increasing data transfer capacity across a network comprises receiving a signal composed of a plurality of data carrying sub-channels at a number of receiving elements (Step 900). A symbol or codeword associated with the signal received on the sub-channel at the receiving element is determined using a maximum likelihood estimation process (Step 904). The determined symbol or codeword is incorporated in the determination of at least one other symbol or codeword (Step 906).

1. A method of determining each of a plurality of data symbols or codewords from a plurality of signals comprising the steps of:
(i) weighting a number of said signals so as to substantially null said number of signals, using weighting apparatus;
(ii) determining a symbol or codeword associated with at least one said, non-nulled signal using a processor arranged to execute a maximum likelihood estimation process upon said at least one, non-nulled signal;
(iii) reducing the number of signals nulled by the weighting apparatus by at least a number of non-nulled signals in step (ii);
(iv) altering a maximum likelihood metric in accordance with the data symbol derived at step (ii); and
(iv) repeating steps (ii) to (iv).

2. The method of claim 1 including selecting signals with highest input power to be nulled during at least one of steps (i) and step (iii).

3. The method of claim 1 including separating frequencies of at least some of the plurality of signals by multiples of a harmonic frequency.

4. The method of claim 1 including orthogonalising each of the plurality of signals.

5. The method of claim 1 including transmitting the plurality of signals at a range of frequencies from a plurality of spatially separated transmitters.

6. The method of claim 1 including providing a plurality of receivers arranged to receive said plurality of signals prior to step (i).

7. The method of claim 1 including determining symbols that form at least part of, codewords, the codewords being associated with streams of symbols input to a transmitter.

8. The method of claim 1 including deriving a matrix of complex weighting coefficients by the processor to be applied to said weighting apparatus in order to null said signals at one of step (i) and step (iii).

9. The method of claim 1 including sampling channel state information data to determine which signals are to be nulled during at least one of steps (i) and step (iii).

10. The method of claim 1 including using the vector Viterbi algorithm at step (ii).

11. A signal receiving apparatus comprising a plurality of receiving elements, weighting apparatus, and a decoder, each of the receiving elements having respective weighting apparatus associated therewith, each of the receiving elements being arranged to receive a plurality of signals transmitted from a plurality of transmitters, the weighting apparatus being arranged to apply a complex weighting function to each of a number of said signals received by the receiving elements at a given frequency in order to null said number of said signals, the decoder being arranged to determine a symbol or codeword associated with a non-nulled signal and to incorporate said symbol or codeword in the determination of at least one further symbol or codeword.

12. Apparatus according to claim 11 including at least four receiving elements.

13. Apparatus according to claim 11 wherein each receiving element has a channel state information (CSI) unit arranged to compensate for distortion to the signal received by the apparatus due to variations in the transmission path of said signal associated therewith.

14. Apparatus according to claim 11 including an FFT unit arranged to separate each of a plurality of sub-carrier signals from said received signals between each receiving element and the decoder.

15. Apparatus according to claim 11 wherein the decoder includes a processor arranged to carry out a maximum likelihood estimation procedure upon a sub-carrier signal received at a receiving element in order to determine the symbol or codeword.

16. Apparatus according to claim 15 wherein the processor is arranged to carry out whole vector Viterbi decoding upon the signal.

17. Apparatus according to claim 11 wherein the apparatus is arranged to execute a method of determining each of a plurality of data symbols or codewords from a plurality of signals, said method comprising the steps of:
(i) weighting a number of said signals so as to substantially null said number of signals, using weighting apparatus;
(ii) determining a symbol or codeword associated with at least one said non-nulled signal using a processor arranged to execute a maximum likelihood estimation process upon said at least one non-nulled signal;
(iii) reducing the number of signals nulled by the weighting apparatus by at least a number of non-nulled signals in step (ii);
(iv) altering a maximum likelihood metric in accordance with the data symbol derived at step (ii); and
(v) repeating steps (ii) to (iv).

18. A method of increasing data transfer capacity across a network comprising the steps of:
(i) receiving a signal comprising a plurality of data carrying sub-channels at a plurality of receiving elements;
(ii) suppressing a component of the signal associated with a given sub-channel received at all but one receiving element;
(iii) determining a symbol or codeword associated with said signal received on said given sub-channel at said one receiving element using a maximum likelihood estimation process; and
(iv) incorporating the symbol or codeword into the maximum likelihood estimation process for the determination of at least one other symbol or codeword.

19. The method of claim 18 including parallelising data and encoding the data as a symbol or a space time codeword prior to transmission of the symbol or codeword over the network.

20. The method of claim 18 including providing more than four receiving elements arranged to receive the signal from the network.

21. The method of claim 18 including applying a whole vector Viterbi decoding to the signal at step (iii).

22. The method of claim 18 wherein the network is in the form of a wireless local area network or a mobile telecommunications network.

23. A computer readable medium having stored therein instructions for causing a device to execute the method according to claim 1.

24. A program storage device readable by a machine and encoding a program of instructions which when operated upon the machine cause the machine to operate as the apparatus according to claim 11.

25-27. (canceled)

28. A computer readable medium having stored therein instructions for causing a device to execute the method according to claim 18.
